(19) United States
(12) Patent Application Publication
(10) Pub. No.: US 2022/0107985 A1
(43) Pub. Date: Apr. 7, 2022

(54) LOCAL RECOMMENDED CONTENT AND DEALS ENGINE

(71) Applicants: DAMIAN NOTO, NEW YORK, NY (US); ABRAHAM BREWSTER, NEW YORK, NY (US); CHARLES HALE, NEW YORK, NY (US)

(72) Inventors: DAMIAN NOTO, NEW YORK, NY (US); ABRAHAM BREWSTER, NEW YORK, NY (US); CHARLES HALE, NEW YORK, NY (US)

(21) Appl. No.: 17/346,142

(22) Filed: Jun. 11, 2021

Related U.S. Application Data
(60) Provisional application No. 63/038,068, filed on Jun. 11, 2020.

(51) Int. Cl. G06F 16/9535; G06Q 30/02

(52) U.S. Cl. CPC G06F 16/9535; G06Q 30/0277

(57) ABSTRACT

A system structured according to principles described above herein.

### PRIORITY CLAIM

This application claims priority to U.S. Prov. Appl. No. 63/038,068 filed Jun. 11, 2020, the entirety of which is hereby incorporated by reference as if fully set forth herein.

### BACKGROUND

At scale, content recommendation engines have become uniform sources of salacious viral streams of exploitive content and advertising. Publishers allow this to exist on their pages for the revenue generated, but it often runs inconsistent with the mission of the site's journalistic intentions and if the publisher is primarily a local source of content the recommendation engine uniform content runs in direct conflict to the site's mission. Nothing previously has attempted to solve the recommendation content option with local news, classifieds, deals, etc. What is needed is a local/classifieds/Deals/News aggregated content platform recommendation engine system.

### DRAWING FIGURES

FIG. 1 illustrates a screenshot generated according to at least one embodiment of the invention;

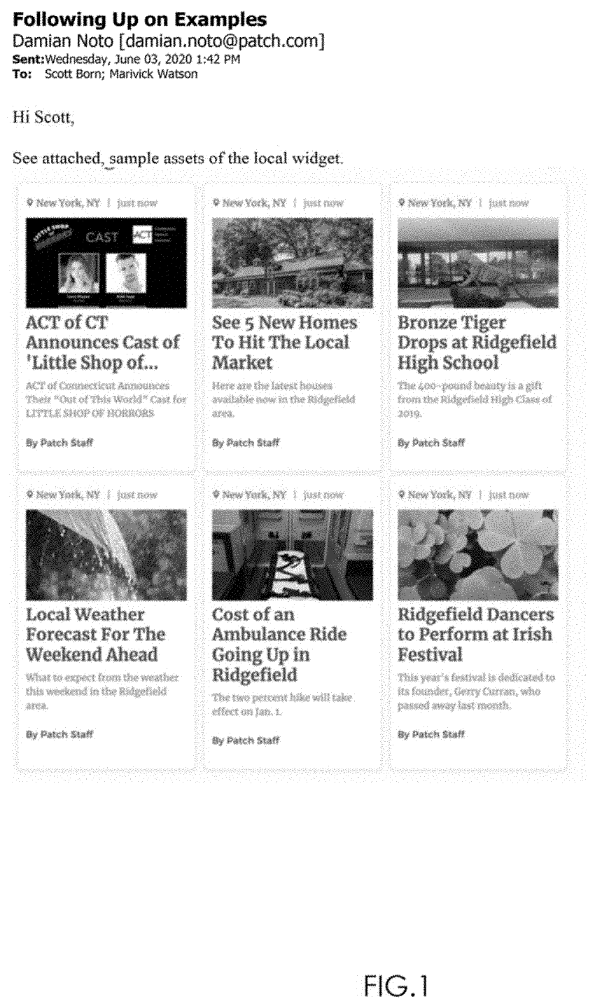

FIG. 2 illustrates a screenshot generated according to at least one embodiment of the invention;

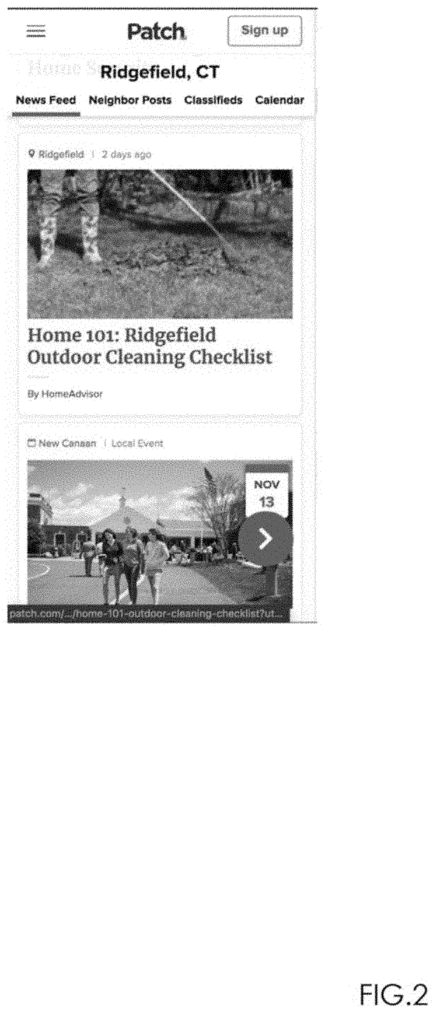

FIG. 3 illustrates a screenshot generated according to at least one embodiment of the invention;

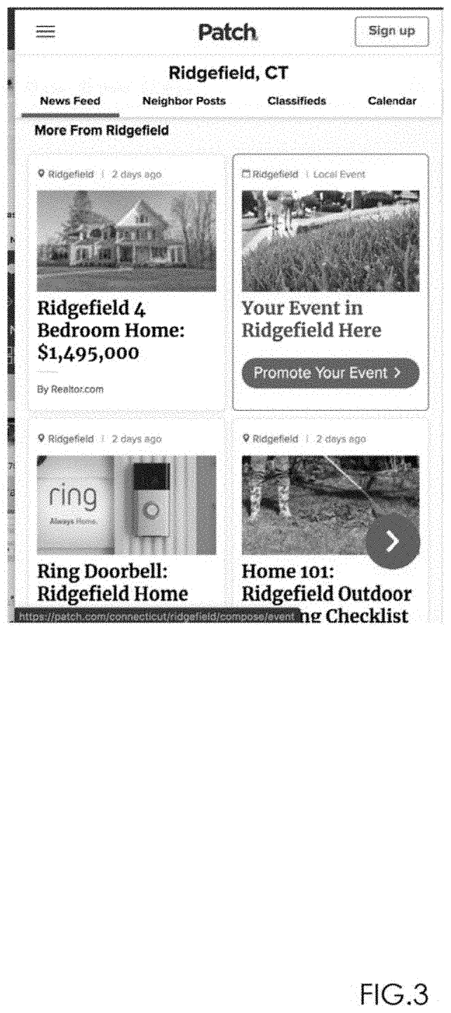

FIG. 4 illustrates a screenshot generated according to at least one embodiment of the invention;

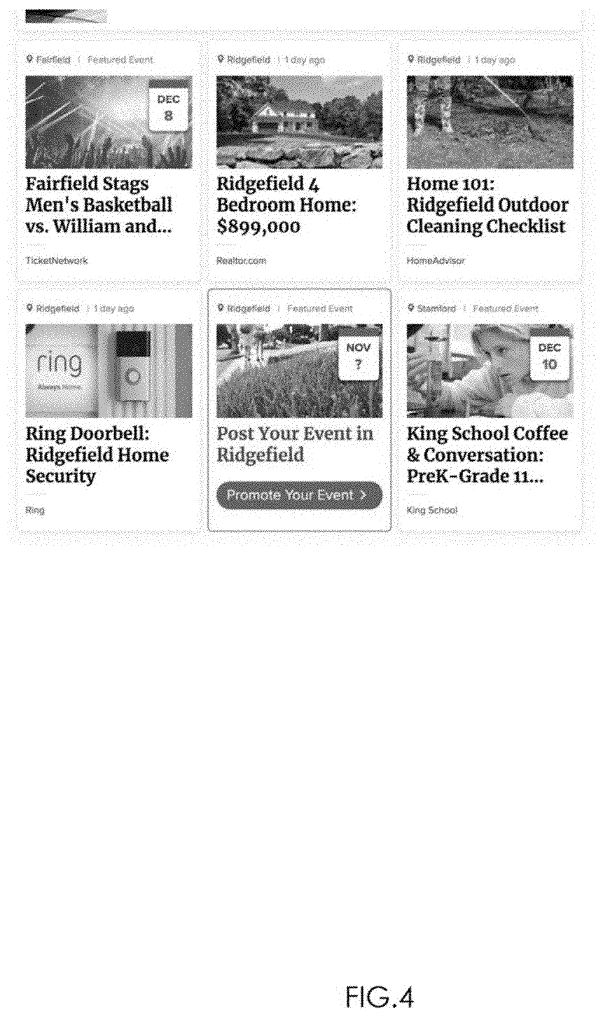

FIG. 5 illustrates a screenshot generated according to at least one embodiment of the invention; and

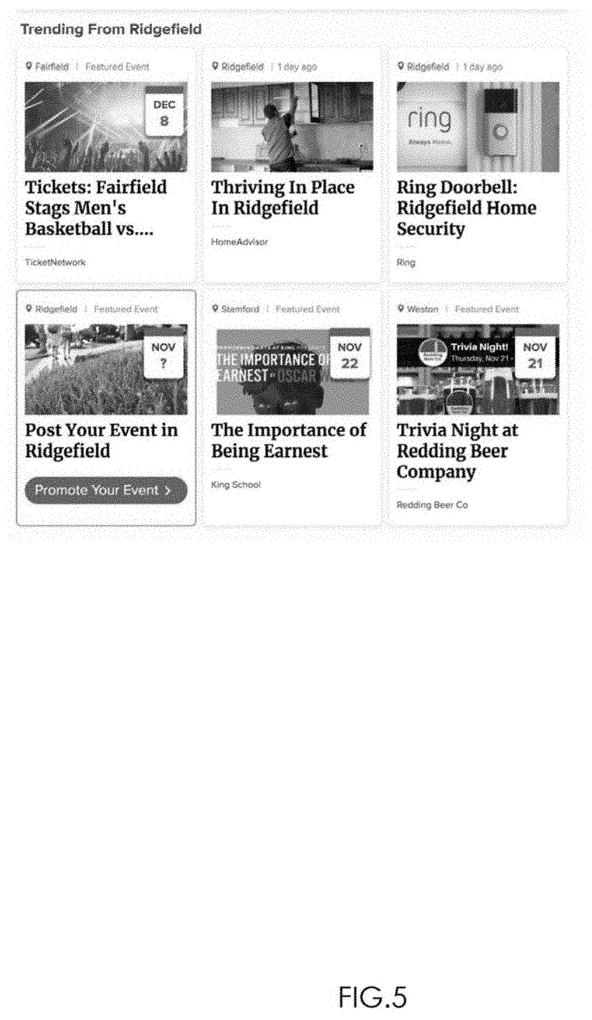

FIG. 6 illustrates a screenshot generated according to at least one embodiment of the invention.

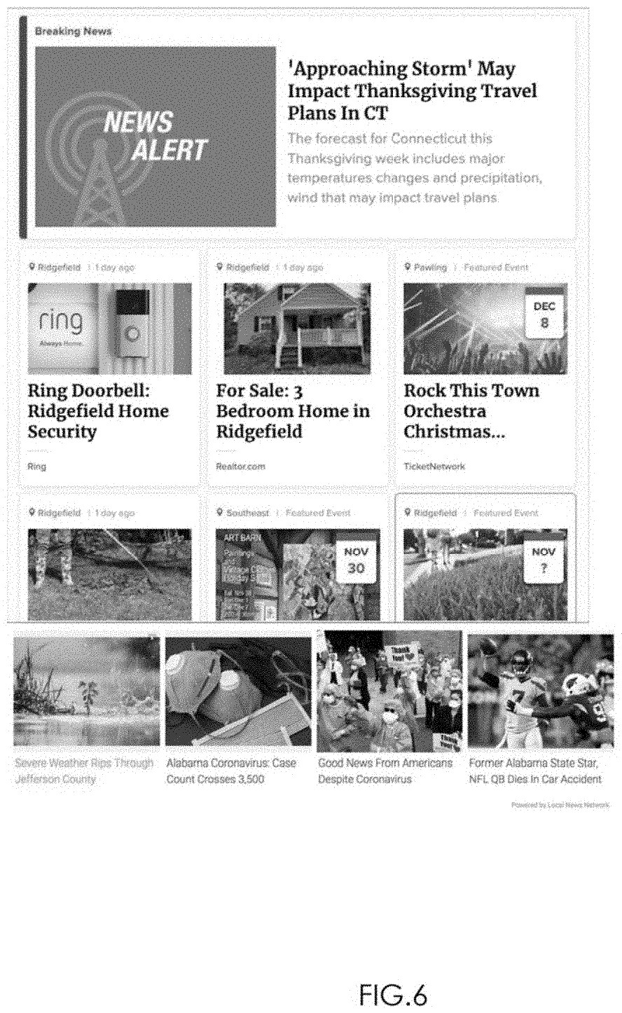

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices and can be used to implement or otherwise perform practical applications.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment of the invention provides a combination of a method of surfacing local geo-targeted aggregated content, deals, advertisements and the device/product for delivery of that content broadly to publishers and web sites and users for monetization. A Local Network Content Recommendation Engine according to an embodiment solves a commercial need by sourcing local relevant content to publisher and user that is both profitable, engaging and consistent with the publishers' journalistic intentions and it does uniquely at scale. Publishers can profit from the local advertising that is sourced into the widget on their site from the engine.

A Local Content Network according to an embodiment can replace non-local content recommendation sources like Taboola with local content that is valuable and unique to the publishers and the readers of that content, creating/providing local aggregated high value, high-signal content, high-engaging content at scale that creates revenue for digital publishers through a digital technology platform for publishing UGC, deals, news and events, classifieds.

An embodiment includes local geo-targeted API's html/j son code. It is designed to be lightweight and fast. It is designed for publisher's to be easily able to add to their page. It will help publishers monetize their pages better to improve the economics for publishers. Specifically designed to help local publishers find a sustainable means of covering the cost of journalism with a local marketplace.

An embodiment of the invention provides geo-located content, deals, classifieds aggregated in a surfaced in an easily uploaded string of code that can be posted or added to a publisher site with limited development time. An embodiment replaces salacious, unattractive, non-local content-recommendation sources with local content that is valuable and unique to the publishers and the readers of that content, creating/providing local aggregated high value, high signal content, high engagement content at scale that creates revenue for digital publishers through a digital technology platform for publishing UGC, deals, news, events, and classifieds. According to one or more embodiments, Widget, HTMIL, and/or Java Script Tags can be used.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

What is claimed is:

1. A system structured according to principles described above herein.
